(19) United States
(12) Patent Application Publication
(10) Pub. No.: US 2006/0041411 A1
(43) Pub. Date: Feb. 23, 2006

(54) Method of designing and drilling systems made using rock mechanics models

(75) Inventors: Zhou Yong, Spring, TX (US); Sujian Huang, Beijing (CN)

Correspondence Address: OSHA LIANG L.L.P., 1221 MCKINNEY STREET, SUITE 2800, HOUSTON, TX, 77010, US

(73) Assignee: Smith International, Inc., Houston, TX (US)

(21) Appl. No.: 11/204,753

(22) Filed: Aug. 16, 2005

Related U.S. Application Data
(60) Provisional application No. 60/603,109, filed on Aug. 19, 2004.

(51) Int. Cl. G06G 7/48

(52) U.S. Cl. 703/10

(57) ABSTRACT

A method for designing a drilling tool or drilling assembly and a drilling tool or drilling assembly made according to the method is provided by simulating, in an earth formation, a rock mechanics effect of the drilling tool or the drilling assembly drilling in the earth formation, graphically displaying to a design engineer the rock mechanics effect of the drilling tool or the drilling assembly drilling in the earth formation, adjusting a value of a design parameter for the drilling tool or drilling assembly, and repeating the simulating and graphically displaying to the design engineer for observing any change in the rock mechanics effect caused by adjusting the value of the design parameter.

This application claims priority to U.S. application 60/603,109, pursuant to 35 U.S.C. §119(e). That application is incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### STATEMENT REGARDING FEDERALLY SPONSORED RESEARCH

Not applicable.

### BACKGROUND OF THE INVENTION

1. Field of the Invention

The invention relates generally to methods of designing and to drilling systems used to drill boreholes in subterranean formations. More particularly, the invention relates to methods of designing drilling systems and to the drilling systems made using rock mechanics models for the borehole and the subterranean formations to evaluate, modify and improve drilling system design and construction.

2. Background Art

The common practice, for the design of drill bits and drilling systems used to drill bore holes in subterranean formations, is to study motion and dynamics of a bit and its interaction with the surface of the rock formation on the bottom of the bore hole. It has been observed by the applicants that central to the activity of forming a hole in a subterranean formation is the removal of rock formation, whether in petroleum industries or in mining industries. The magnitude of stress, the magnitude of strain energy, the distribution of stresses, the distribution of strain energies, and other physical parameters underneath the bottom of a hole determine the penetration rate of a drilling system. Prior to the present invention, little investigation existed to look into the reaction of a rock formation in response to the drilling tool. The focus has always been on the effects of the formation on the drilling tool. There is a general awareness of internal strength and capacity of rock formations against material removal when actions are imposed by a mechanical drilling system. However, previously the application of such internal strength and capacity information has not been utilized for the design of drilling tools and drilling systems.

### SUMMARY OF THE INVENTION

The invention relates to methods for designing and to drilling systems used to drill boreholes in subterranean formations using rock mechanics and properties of a subterranean formation such as magnitude of stresses, magnitude of strain energies, distribution of stresses, distribution of strain energies, and other physical parameters underneath the bottom of a hole. More particularly, the invention relates to methods of designing drilling systems and to the drilling systems made using rock mechanics models for boreholes in subterranean formations to evaluate, modify, and/or improve drill bit, drilling tool, and drilling system design and construction.

According to one embodiment, the parameters of rock mechanics underneath the bottom of the hole are used to model, design, and make a drilling tool, a drilling system, or a drilling process for the best performance in terms of rate, cost, efficiency, and consistency of drilling. Parameters include stresses, strains, and energies, displacements, fracture toughness, and/or fragmentation toughness, coupled together with rock physical properties like hardness, viscosity, abrasiveness, yield stresses, Young's modulus, Poison's ratio, and shear modulus.

According to one embodiment, it has been found useful to focus attention to the distribution of parameters on a surface whether the surface is flat or curved, immediately under the bottom of a borehole.

According to an alternative embodiment, additional attention is also paid to a lateral surface around the bottom of a borehole.

According to another embodiment the parameters of interest are predictors of rock failure modes, such as critical stresses, critical energies, stress distributions, and energy distributions.

The physics of parameter patterns on the surfaces will provide guidelines for drill bit designs, bottom hole assembly (BHA) designs, drilling operation setups, and establishing operating parameters. One of the advantages of this unique approach is that it is independent of the types of drill bits; in other words, it is universally applicable to standard rock bits, roller cone bit, drag bits, and percussion bits, as well as to less standard drilling tools, such as water jets, thermal fracture tools, laser melting tools, sonic tools, finite blasting tools and other non-standard drilling tools. The design process may be viewed as an “inverse design” function, in which the focus is on using rock mechanics to model the effects of force(s) applied to an earth formation and to graphically present rock strength parameters indicating failure of the earth formation and efficient removal of earth formation material. A drilling tool can be designed to have the characteristics for producing the failure mode in the earth formation, regardless of the type or nature of the drilling tool.

Other aspects and advantages of the invention will be apparent from the following description, figures, and the appended claims.

### BRIEF DESCRIPTION OF THE DRAWINGS

FIG. 1 shows a schematic depiction of a portion of a drilling process.

FIGS. 2(a)-(b) show three-dimensional depictions of meshed surfaces for viewing physical parameters such as stresses and energy.

FIG. 3 is a flow diagram of a method in accordance with one embodiment of the invention.

FIG. 4 is a flow diagram of a method in accordance with an alternative embodiment of the invention.

FIG. 5(a) shows a sample of a contour chart of maximum principal stress within a circular border of a viewing surface defined by FIGS. 2(a)-(b).

FIG. 5(b) shows a sample of a fringe chart of maximum principal stress within a circular border of a defined viewing surface.

FIG. 6 shows a sample of a contour chart of maximum principal stress within a square border surface.

FIG. 7(a) shows a sample of a contour chart of Von Mises stress within a circular border of a viewing surface.

FIG. 7(b) shows a sample of a fringe chart of Von Mises stress within a circular border of a viewing surface.

FIG. 8(a) shows a sample of a contour chart of strain energy within a circular border of a viewing surface.

FIG. 8(b) shows a sample of a fringe chart of strain energy within a circular border of a viewing surface.

FIG. 9 shows an alternative regional division of a circular border surface underneath a bottom of a bore hole for evaluation of parameter distributions according to certain aspects of the invention.

FIG. 10 shows another alternative regional division of a circular border surface underneath a bottom of a bore hole for evaluation of parameter distributions according to certain aspects of the invention.

### DETAILED DESCRIPTION

According to one embodiment of the present invention, a method is provided for revealing rock strength properties, conditions, or characteristics that are predictors of subterranean material failure modes, such as critical stresses, critical energies, stress distributions, energy distributions, or other parameters within or below the bottom of a bore hole in a subterranean rock formation.

According to another embodiment of the present invention a method is provided for determining the critical stresses, critical energies, stress and energy distributions, or other parameters within or below the bottom of a bore hole in a subterranean rock formation, for the most efficient rate of rock material removal.

These parameters are calculated or determined from external interactions between the rock formation and a drill bit, a drilling tool, and/or a drilling system. As used herein, a drilling tool refers to any drilling tool whether a standard rotary drag bit, a rotary roller cone bit, a percussion drilling tool, or another less standard drilling tool such as a thermal tool, a sonic tool, a blasting tool, a laser tool or any other standard or non-standard device for penetrating a subterranean formation (all referred to herein as a “drilling tool”).

According to one embodiment of the invention, the effects that forces have on the rock formation are modeled, simulated, or calculated. The base forces modeled can be independent of a particular drilling tool design, or can be the forces determined for a known or assumed base drilling tool design, with or without other drill string components attached, and with or without operating features or other down hole features, such as drilling mud, depth, temperature, pressure, and etc. An improved failure mode model is pursued, whether the failure mode is in terms of critical rock stresses, critical energies, rock stress distributions, energy distributions, combinations of such rock strength failure modes, or other failure mode predictor parameters. An improved model for a rock formation failure mode is in effect an improved model for the most efficient drilling, most effective drilling, highest rate of penetration and/or highest rate of formation material removal. An improved design of a drilling tool is designed or an improved drilling mechanical system is designed to obtain such improved failure mode predictors.

In practice, input of known constants may include the rock material properties, geometrical dimensions of a drill bit, dimensions of a drilling tool, dimensions of a drilling tool assembly, weight on the drilling tool, torque on the drilling string, depth of a borehole, properties of the drilling mud, and bottom hole pressure. For example, parameters of rock mechanics underneath the bottom of the hole are used to model, design, and make a drilling tool, a drilling system, or a drilling process for the best performance in terms of rate, cost, efficiency, and consistency of drilling. For example, parameters generated by the rock formation model may include one or more of stresses, strains, energies, displacements, fracture toughness, and/or fragmentation toughness, which may also be coupled together with rock physical properties like hardness, viscosity, abrasiveness, yield stresses, Young's modulus, Poison's ratio, and shear modulus.

Those skilled in the art of rock mechanics will understand from the present disclosure, how to apply known modeling techniques and calculations for determining the rock strength properties, conditions, or characteristics that are predictors of subterranean material failure modes. Examples of such rock strength properties that are found useful as predictors of subterranean formation failure modes include maximum principal stresses, maximum von Mises stress, maximum shear (Tresca) stress, nominal stress, maximum energy concentration, maximum displacement, maximum strain energy, most uniform distribution of maximum principal stresses, most uniform distribution of maximum von Mises stress, most uniform distribution of shear (Tresca) stress, most uniform distribution of nominal stress, most uniform distribution of maximum energy concentration, most uniform distribution of displacement, most uniform distribution of maximum strain energy, and most uniform distribution of combined stress and energy distributions within or below the bottom of a bore hole in a subterranean rock formation.

Particularly, it will be understood that in continuum rock mechanics there are known equations and relationships that can be used to determine parameters of rock strength, such as stress and energy, by utilizing numerical methods such as finite element analysis (FEA) methods, or boundary element methods (BEM). For example, it will be understood that typically there is a set of 15 partial differential equations, including a set of equilibrium equations, a set of geometry equations, and a set of physical stress and strain relationships (Young's modulus and Poison's ratio) that can be used in FEA methods to calculate, simulate, and model the effects of forces on a subterranean rock formation. Such numerical methods can be used by those skilled in the art to produce charts and graphs of results over a defined surface below a bottom hole in a geological formation. Commercial software is available for the numerical solution methods. For example, an FEA program is available under the name ABAQUS, a product of ABAQUS, Inc. Also, for example, a book titled Boundary Element Programming, by Xiao-Wei Gao, Trevor G. Davies, published by Cambridge (2002), includes a CD-ROM containing BEM source code for use by the reader.

Alternatively, it will be understood that analytical methods can also be used to produce charts and graphs of results over a defined surface below a bottom hole in a geological formation. Commercial and private analytical models abound and are, for example, used in a variety of forms by mechanics engineers and university professors for many other rock mechanics modeling purposes.

According to one embodiment of the invention, a contact mechanics model is used to calculate the stress distribution on a given surface. A set of contour and/or fringe charts of stress distribution is presented graphically to the drilling system design engineer. Known constants and assumed contact pressure loading applied to an FEA model, or to another type of model, will generate a group of stress patterns, or other parameter patterns, as the base from which to produce an improved drilling tool or drilling system design. In practice, a design engineer views the contour charts, fringe charts, or both (or numerical graphical equivalents of those charts), and adjusts one or more parameters to obtain a new set of contour charts, fringe charts, or both. The effect of the adjustment can be observed for evaluation. The process may be repeated to model the 3-D stresses. stress distribution, strain energies, energy distributions, and/or stress and strain energy distributions to obtain a drill bit design, drilling tool design, a drilling string design, or a drilling system design that produces the desired characteristics when drilling in a rock formation. In one embodiment, the process of presenting a map or chart of resultant effects, observing the resultant chart or charts, changing a design parameter, presenting a chart with the change, and observing or otherwise evaluating the results of the change is repeated to obtain an improved (i.e., a better performing) drill bit design, drilling tool design, or drilling system design.

According to another embodiment of the invention, a point forces model is used to calculate the stress distribution on a given surface. A set of contour and fringe charts of stress distribution is presented graphically to the drilling system design engineer. Known constants and assumed point forces are applied to an FEA model, or to another type of model, to generate a group of stress patterns, or parameter patterns, as the base from which to produce an improved drilling tool or drilling system design. A design engineer views the contour charts, fringe charts or both, and adjusts one or more parameters to obtain a new set of contour charts, fringe charts or both, (or numerical graphical equivalents of those charts) and the effect of the adjustment is observed. The process may be repeated to model the 3-D stresses, stress distributions, strain energies, energy distributions and/or stress and strain energy distributions to obtain a drill bit design, a drilling tool design, a drilling string design or drilling system design that produces the desired characteristics when drilling in a rock formation. In one embodiment, the process of presenting a map or chart of resultant effects, observing the resultant chart or charts, changing a design parameter, presenting a chart with the change, and observing the results of the change is repeated to obtain an optimum drill bit design, drilling tool design, drill string design, or drilling system design.

According to one aspect of the point force embodiment of the invention mentioned above, it has further been found that generally at a depth of only about three times the maximum diameter of a given contact pressure area, a point force of equivalent total magnitude applied in place of the contact area will have substantially the same effect on the rock strength variables in the formation under the bottom of the bore hole. Thus, it has been found according to one aspect of the invention that modeling point forces can simplify and speed calculations and potentially reduce computational power required without hindering the usefulness of the results.

In the design of a drilling tool, according to one embodiment of the invention, it has been found useful to use rock mechanics modeling of a subterranean formation acted upon by an assumed drilling tool design to provide contour charts and/or fringe charts (or equivalent information) of stress and energy. Particularly, according to one embodiment, one or more contour charts and/or fringe charts of stress or energy are presented to a drilling tool design engineer, and the engineer views the contour or contours for characteristics such as maximums, minimums, averages, and distributions of stress, energy or other mapped parameters useful for the prediction of formation failure modes or material volume removal rates. The design engineer modifies a parameter of the modeled drilling tool design, and the contour chart and/or the fringe chart (or equivalent information) is obtained on the basis of the modification. The design engineer observes and evaluates the results and selects the design to obtain an improved design for a drilling tool, or repeats the process to obtain a further improved design. The process can be repeated until a design has a desired performance characteristic or a combination of desired performance characteristics. Thus, the process can be repeated until a design is improved or until the design is optimized. For example, the process might be repeated until the design is improved for a particular purpose, improved with respect to a particular performance characteristic, or improved with respect to a selected combination of performances characteristics. In some cases, the process may be repeated until the design is optimized for a particular purpose, optimized with respect to a particular performance characteristic, or optimized with respect to a selected combination of performances characteristics.

In the design of a drilling tool, according to another embodiment of the invention, it has been found useful to use rock mechanics modeling of a subterranean formation acted upon by an assumed force or an assumed set of forces to provide contour charts, fringe charts, and/or equivalent information of stress and energy. Particularly, according to one embodiment, one or more contour charts and/or fringe charts of stress or energy are presented to a drilling tool design engineer, and the engineer views the contour or contours for characteristics such as maximums, minimums, averages, and distributions of stress, energy, or other mapped parameters useful for the prediction of formation failure modes or material volume removal rates. The design engineer modifies the modeled point force, set of point forces, modeled contact pressure loading, or set of contact pressure loading. Then a contour chart, fringe chart, and/or equivalent information is obtained on the basis of the modification. The design engineer observes and evaluates the results and accepts the assumed force or set of forces for purposes of designing or selecting a drilling tool that provides such force or forces. The process can be repeated until a force or set of forces is modeled to provide a desired performance characteristic or a combination of desired performance characteristics. A drilling tool design to provide such forces can then be made, selected, or otherwise provided. Thus, the process can be repeated until a force or a set of forces for a drilling tool design is improved, or until the design is optimized. For example, the process might be repeated until the design is improved for a particular purpose, improved with respect to a particular performance characteristic, or improved with respect to a selected combination of performances characteristics. In some cases, the process may be repeated until the design is optimized for a particular purpose, optimized with respect to a particular performance characteristic, or optimized with respect to a selected combination of performances characteristics.

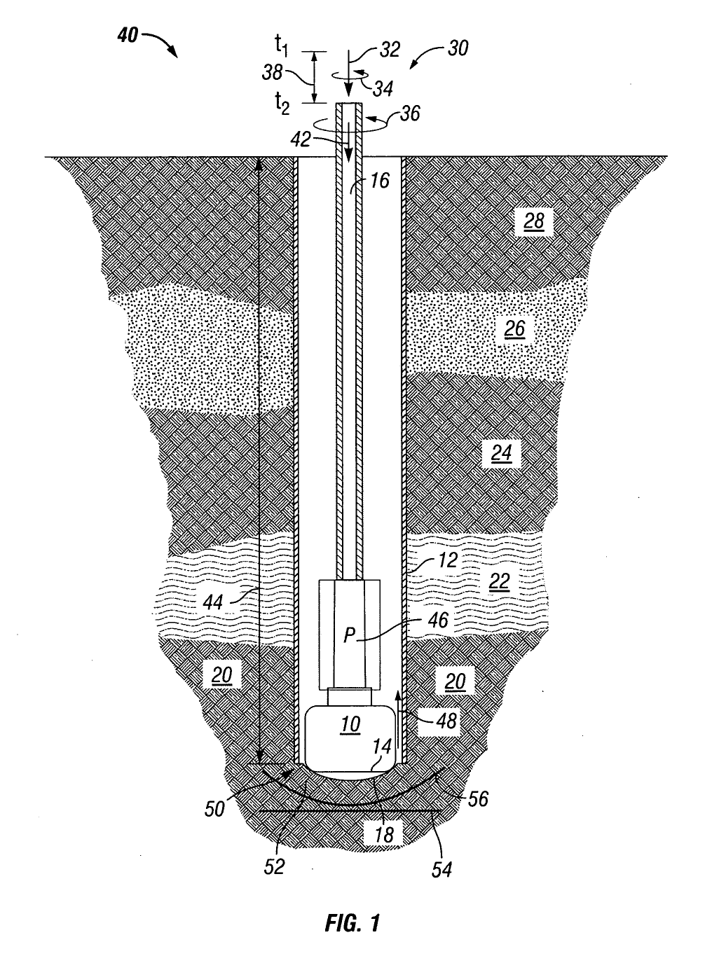

In FIG. 1, a portion of a drilling system 40 in accordance with one embodiment of the invention is depicted at a point in time t₂ (shortly after time t₁) during a drilling process. A drilling tool 10 is used to form a bore hole 12. In this embodiment, the drilling tool 10 is depicted as a drill bit 14 that is attached to a drill string 16. The drill string 16 is operatively coupled for operating the drilling tool 10 against a bottom 18 of the bore hole 12 formed in a subterranean geological rock formation 20. In the case of a rotary drill bit 14, operating the drill bit 14 will entail rotating the drill bit 14. In other cases, operating the drilling tool 10 may employ another mechanism, such as with percussion drilling tools, hydraulic jet drilling tools, thermal fracture drilling tools, laser drilling tools, sonic drilling tools, micro blasting drilling tools, and others. In each case, the desired result is to cause the earth formation to fail at the area of desired penetration and material removal. It will be understood that the bore hole 12 may be formed through a single type of rock formation 20 or a plurality of types of subterranean formations 20, 22, 24, 26 and 28, each having different or similar rock strength properties.

In the embodiment shown in FIG. 1, the drilling system 40 further includes an operating set-up 30 including downward force 32 on the drilling tool (often referred to as weight on bit or “WOB”), torque 34, rotation speed 36 and rate of penetration 38. All of these operating parameters may be referred to as parts of the entire drilling system 40. Other features of the entire drilling system 40 may also include drilling mud 42, depth of the hole 44, pressure in the hole 46, rate of material removal 48, and etc.

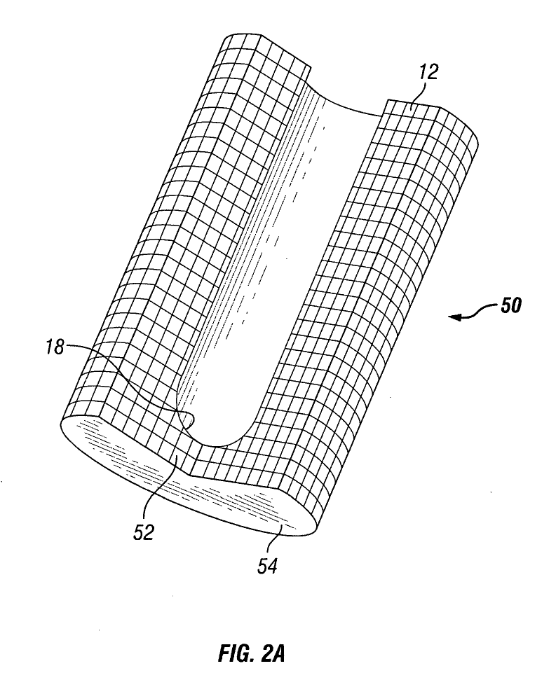

FIGS. 2(a) and 2(b) show a schematic block 50 of the formation 20 (schematically taken from a position as indicated in FIG. 1) surrounding the bottom hole 18. According to one embodiment of the invention, one or more aspects of the block 50 of formation 20 are modeled using rock mechanics data for the type of formation material considered. For example, a model of a block of formation 50 can be modeled that includes a portion 52 of the block 50 that is below the bottom hole 18. This portion 52 is found to be of particular interest with respect to determining and predicting the occurrence of rock formation failure modes in reaction to the actions of the drilling system 40. Determining, observing, and/or evaluating the reaction in the formation to the actions of the drilling tool 10 at the bottom 18 of the bore hole 12, where material is to be removed, allows the design engineer to predict the effectiveness of applied forces or other actions of the drilling tool 10 for penetrating the formation and removing material. It has been found that determining resultant parameters such as stress, strain, energy, displacement, fracture/fragmentation, and other rock formation strength parameters or rock mechanics parameters is useful for predicting the initiation, occurrence, and propagation of failure modes and mechanisms in the rock formation. For example, mapping such resultant stresses, strains, energies, displacements, and/or fractures in a plane surface view 54, a curved surface view 56, or other surface views in the 3-D block of formation 50, can facilitate a drilling system design engineer in the design of drilling tools.

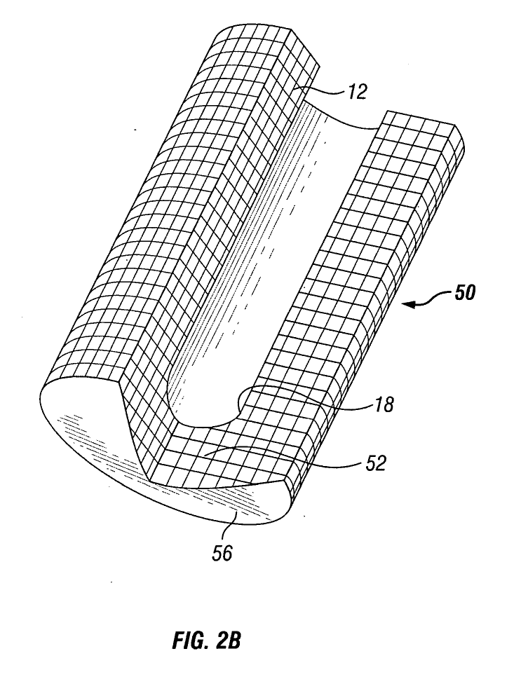

FIG. 3 shows a flow diagram of a design process 80 according to one embodiment of the invention. An initial design for a drill bit, drilling tool or drilling system is assumed 82. Rock mechanics data 86 is used to model 84 the earth formation 20 and the resultant reaction of the assumed design of the drill bit, drilling tool, or drilling system is graphically presented 88 to the design engineer. The presentation may be in the form of one or more charts, maps, or other graphical depictions or “views”, of one or more surfaces defined in the formation 50 at a portion 52 below the bottom 18 of a bore hole 12 (see FIGS. 1, 2(a) and 2(b)). For example, for a plane surface 54 or a curved surface 56, the results may be mapped in the form of a contour chart, a fringe chart, or both. The presented results are evaluated 90 to see whether an adequate rock formation failure mode is accomplished. If one or more of the modeled rock strength parameters predict an adequate failure mode in the formation, the design may be accepted 94.

Alternatively, the design may be modified 92, modeled again 84, the results presented 88, evaluated 90, and further modified 92 repeatedly until the design is accepted 94. When any design parameter (or set of design parameters) is accepted 94, the process 80 can begin 96 with respect to other design parameters (which may include any already accepted design parameter) by returning 98 to the beginning and assuming 82 another design parameter. The reaction of the formation to such design parameters is modeled 84, the results presented 86, evaluated 90, and the other design parameter accepted 94 or modified 92 and the process repeated. Alternatively, a plurality of different drilling tool designs may be assumed and the formation reaction modeled for each design modeled. Then, the one design with the best results for producing a failure mode in the formation can be selected. By repeating the process, or by selecting an improved design, the drilling tool performance is improved. A drilling tool can be made 100, or otherwise provided, according to the accepted, selected or improved design.

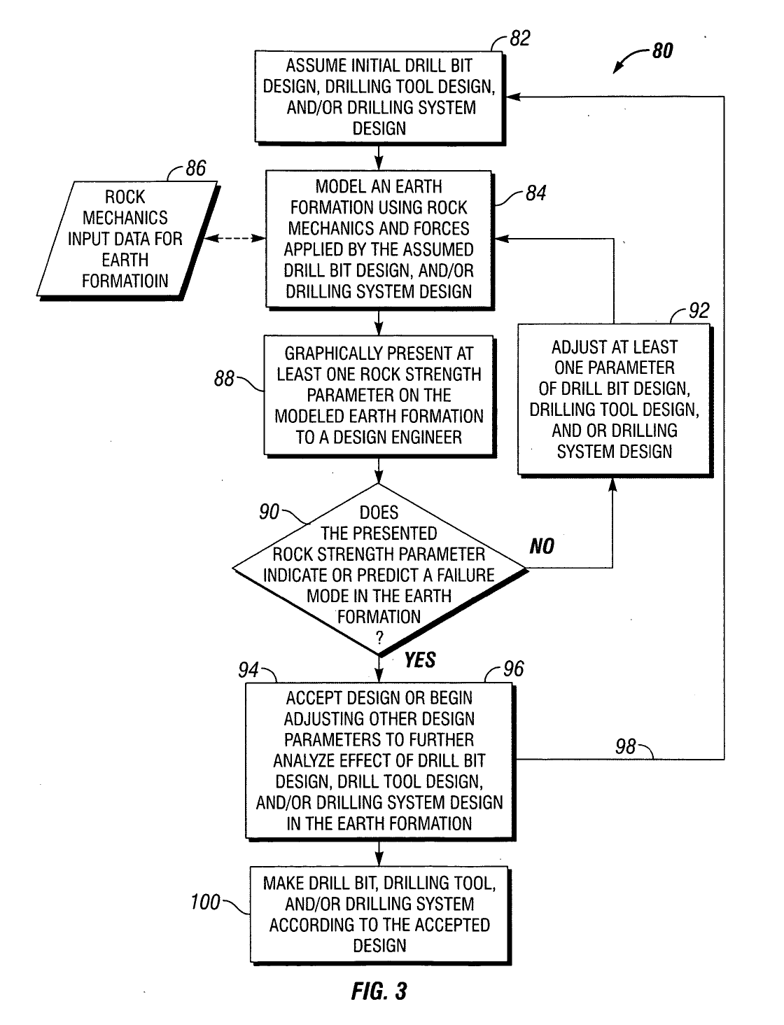

FIG. 4 shows a flow diagram of an alternative design process 110 according to another embodiment of the invention. An initial force, or set of forces, is assumed 112. Rock mechanics data 116 is used to model 114 the earth formation 20 and the resultant reaction of the assumed force, or set of forces, is graphically presented 118 to the design engineer. The presentation may be in the form of mapping or graphically depicting one or more “views” of one or more surfaces. For example, a flat surface 54 or a curved surface 56 can be defined in the formation 50 at a portion 52 below the bottom 18 of a bore hole 12 (see FIGS. 1, 2(a), and 2(b)). For a plane surface 54 or a curved surface 56, the results may be mapped in the form of a contour chart, a fringe chart, or both. The presented results are evaluated 120 to determine whether an adequate rock formation failure mode is accomplished by the assumed applied force or set of applied forces. If one or more of the modeled rock strength parameters predict an adequate failure mode in the formation, the forces may be accepted 126 for the drill bit, drilling tool, or drilling system design. Alternatively, the force, or set of forces, may be modified 124, modeled again 112, the results presented 118, evaluated 120, and further modified 124, repeatedly, until the force or set of forces is accepted 126. When one or more of the forces is accepted 126, the process can begin again 128 with respect to other forces by returning to the beginning and assuming new forces, or by assuming the accepted forces and any newly added force or set of forces 112. The reaction of the formation to such combination of forces can be modeled 114, the results presented 118, evaluated 120, and the other forces accepted 126 or modified 124 and the process repeated. By repeating the process, an improved force or set of forces is obtained. Alternatively, a plurality of different forces or different sets of forces may be assumed and modeled and the force or forces that produce the improved results for producing a failure mode in the formation can be selected. A drill bit, drilling tool, and/or drilling system can be made 130, or otherwise provided, according to the accepted, selected, or optimum force or set of forces.

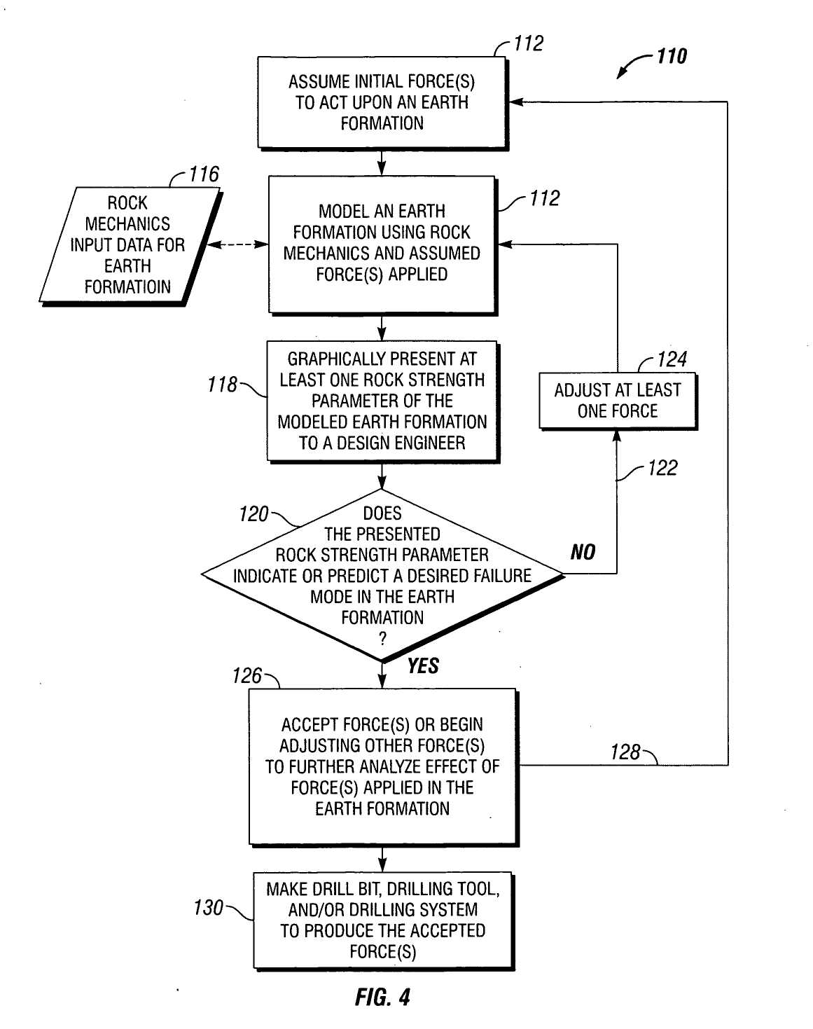

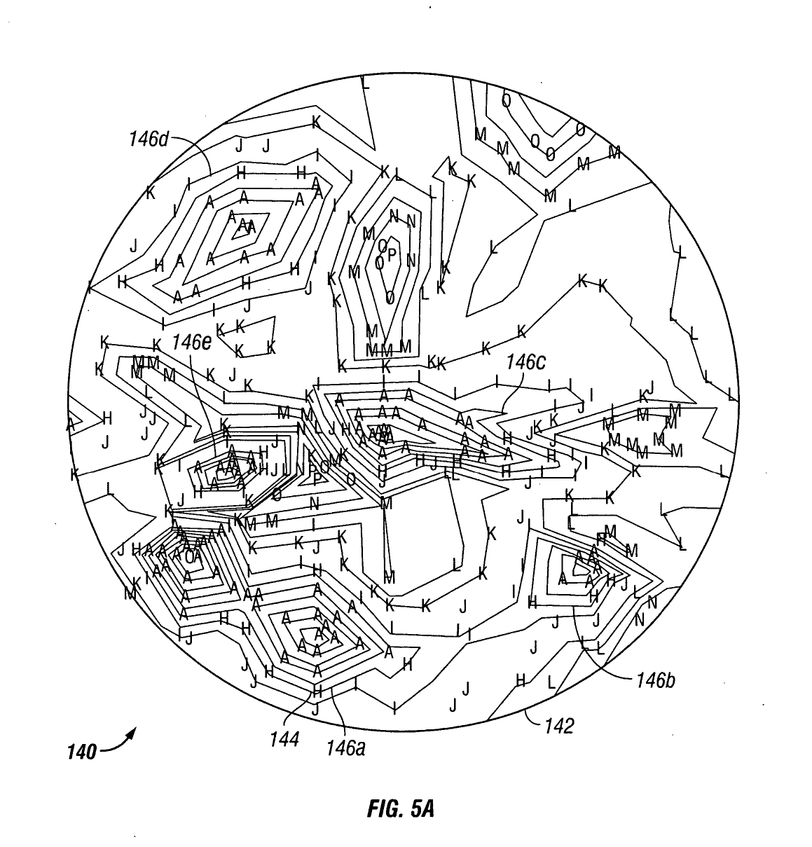

With reference to FIGS. 5(a) and 5(b), it has been found by the present inventors to be useful to map or graphically depict modeled rock strength characteristics for a geological formation, such as on a contour chart FIG. 5(a) or on a fringe chart 5(b) of maximums for characteristics, such as maximum principal stresses. Other maximums, such as maximum strain, maximum energy, maximum displacement and the like can also be mapped and presented to the design engineer. It has further been found to be useful to present such observable criteria on charts or other graphical depictions to a design engineer for designing a drill bit,-drilling tool, or drilling system, or for selecting such a drill bit, drilling tool, or drilling system design.

According to an alternative embodiment of the invention, rock mechanics can be used to model multiple drilling tool designs operating in a geological formation. Then, the modeled drilling tool design that generates the highest maximum principal stress on a view of one or more defined surfaces in the formation can be selected. A drilling tool can be made according to the selected design.

An example of a contour chart 140 of maximum principal stress is shown in FIG. 5(a) within a circular border 142, corresponding generally to the shape of a bottom hole surface 54 or 56. Each like value for maximum principal stress is indicated with a like data point letter A-O connected by a contour line. For example the principal stress 144 of value “H” MPA, is caused to occur in the formation modeled due to the set of forces assumed and applied to the model. Maximum principal stresses from a stress value “H” MPA up to a stress value “A” MPA are found inside the areas bordered by contour lines 146(a)-146(e) interconnecting stresses with value “H” MPA. For example, where the value “H” indicates a critical value for failure of the earth formation modeled, the design engineer can evaluate the contour chart to determine whether a drilling tool producing such a contour map will be good for effective or efficient drilling.

FIG. 5(b) shows an example of a fringe chart 150 of maximum principal stress within a circular border 152, also corresponding generally to the shape of a bottom hole surface 54 or 56. Each like range of values for maximum principal stress, for example, the range 154 from value “H” to value “I,” is indicated with an area of a particular color or a particular gray scale shading 156.

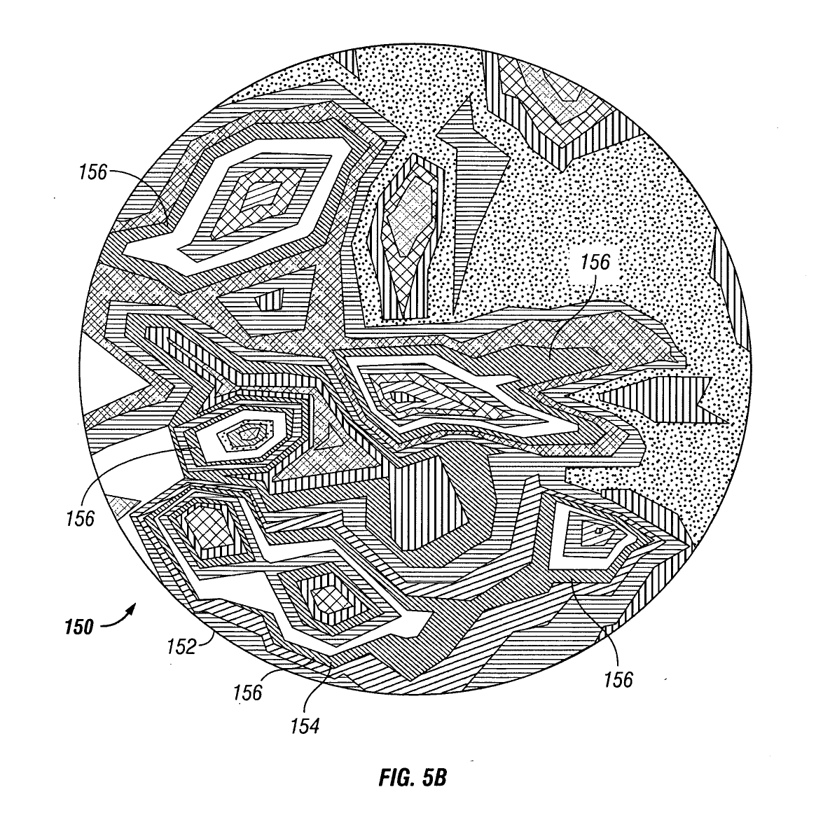

The shape of the chart border need not be the same as the shape of a round hole, and FIG. 6 shows an example of a contour chart 160 of maximum principal stress within a view of a surface having a rectangular or square border 162. For example, any block subdivision of the formation might be of interest and thus modeled in terms of a square surface. Alternatively, for example, a cylindrical surface vertically surrounding the bottom of the bore hole might be conveniently viewed in a two dimensional depiction as a flattened out rectangular surface.

According to an alternative embodiment of the invention, rock mechanics can be used to model multiple drilling tool designs operating in a geological formation. Then, the modeled drilling tool design that generates the highest maximum energy concentration on a view of one or more defined surfaces in the formation can be selected. A drilling tool can be made according to the selected design.

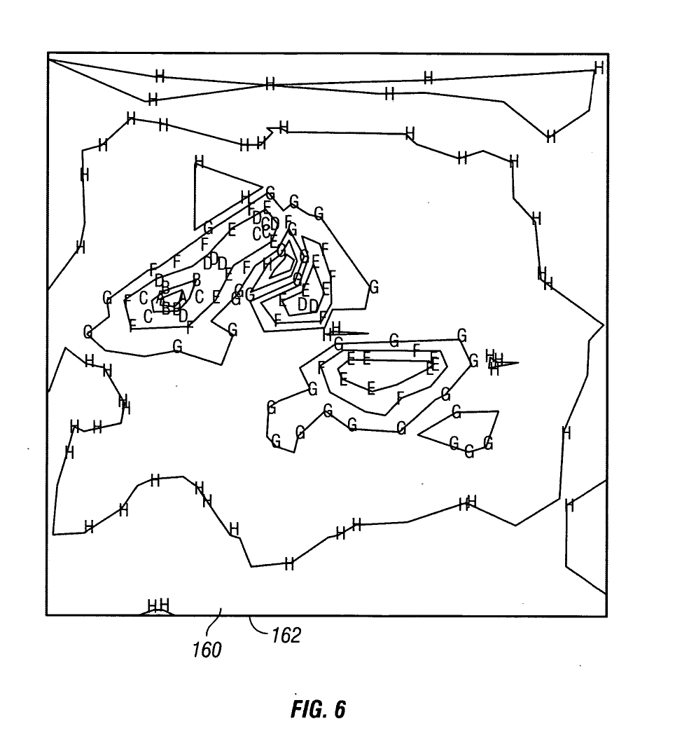

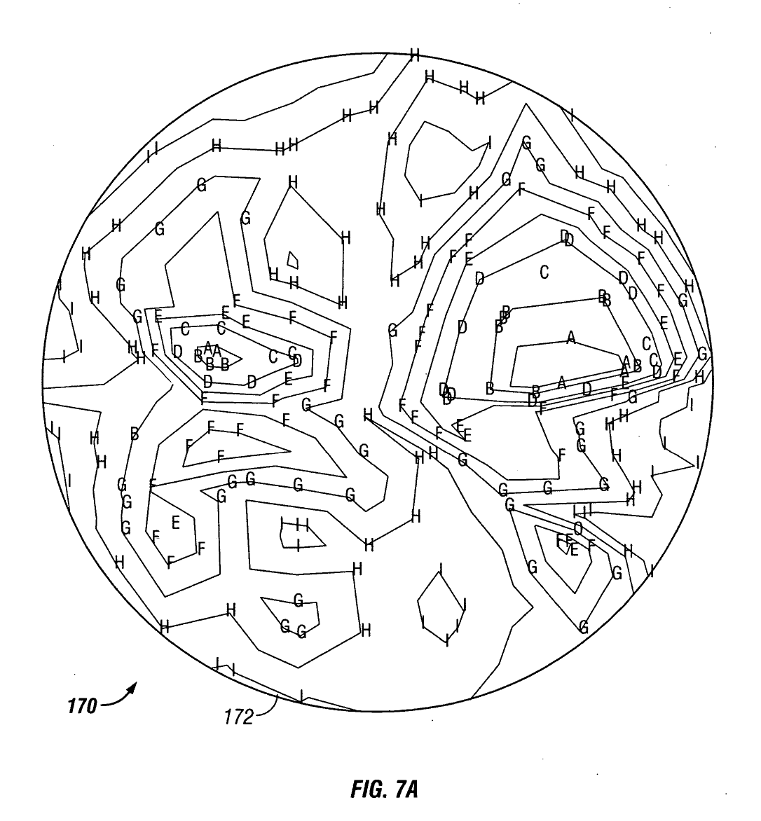

FIG. 7(a) shows an example of a contour chart 170 of von Mises stress within a circular border 172 of a bottom hole surface. Thus, according to an alternative embodiment of the invention, rock mechanics can be used to model multiple drilling tool designs operating in a geological formation. Then, the modeled drilling tool design that generates the highest maximum von Mises stress on a view of one or more defined surfaces in the formation can be selected. A drilling tool can be made according to the selected design.

FIG. 7(b) shows an example of a fringe chart 180 of von Mises stress within a circular border 182 of a bottom hole surface. Either or both the contour chart 170 of FIG. 7(a) and/or the fringe chart 180 of FIG. 7(b) may be used by the design engineer to observe and evaluate parameters, such as von Mises stress, which can be a predictor of rock formation failure modes. When the rock formation fails in reaction to the modeled drilling tool, it will be understood that the drilling tool is operating for its intended purpose. Improving (or in an ideal situation optimizing) the predicted failure mode caused in the modeled formation by the assumed drill bit, drilling tool, drilling system or by the assumed force or set of forces in the formation, therefore improves (or optimizes) the design of the drill bit, drilling tool, or drilling system.

According to an alternative embodiment of the invention, rock mechanics can be used to model multiple drilling tool designs operating in a geological formation. Then, the modeled drilling tool design that generates the highest maximum shear (Tresca) stress on a view of one or more defined surfaces in the formation can be selected. A drilling tool can be made according to the selected design.

According to an alternative embodiment of the invention, rock mechanics can be used to model multiple drilling tool designs operating in a geological formation. Then, the modeled drilling tool design that generates the highest maximum nominal stress, defined for a rock strength measurement, on a view of one or more defined surfaces in the formation can be selected. A drilling tool can be made according to the selected design.

According to an alternative embodiment of the invention, rock mechanics can be used to model multiple drilling tool designs operating in a geological formation. Then, the modeled drilling tool design that generates the highest maximum displacement on a view of one or more defined surfaces in the formation can be selected. A drilling tool can be made according to the selected design.

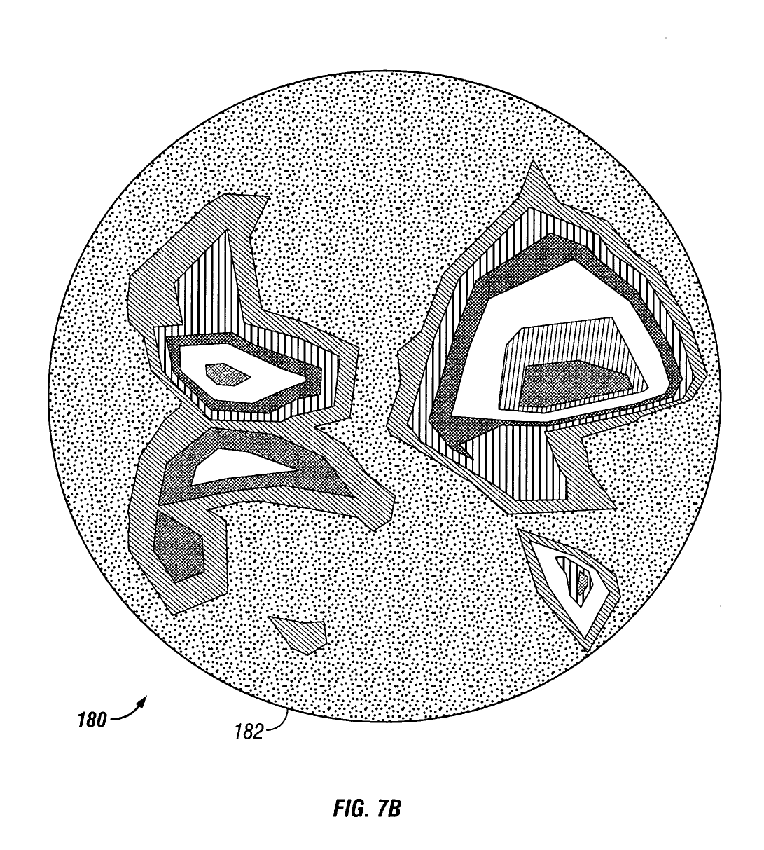

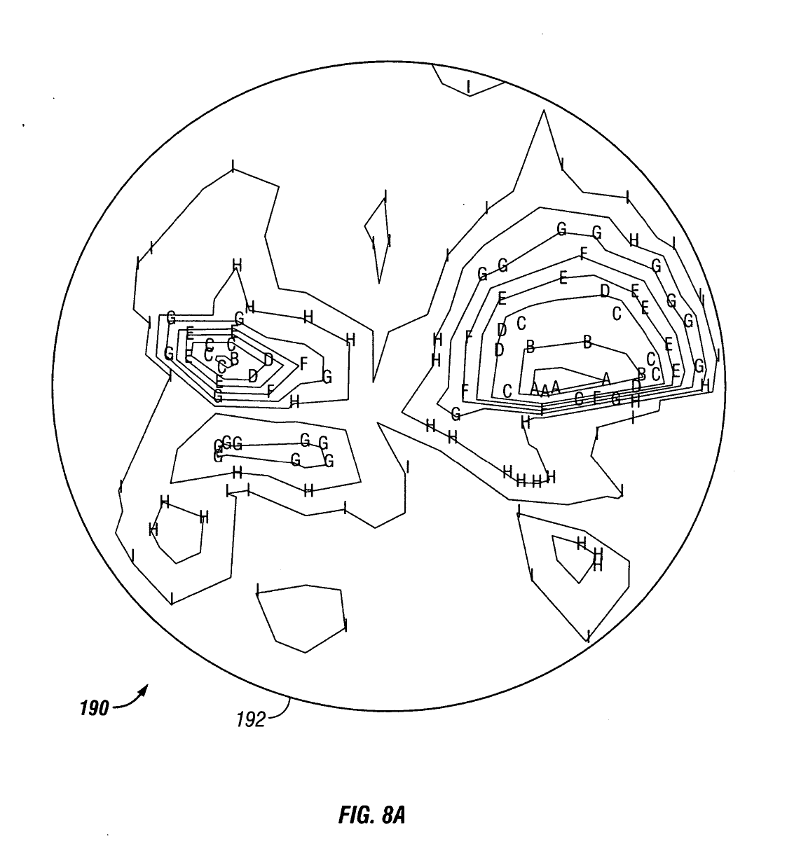

FIG. 8(a) shows an example of a contour chart 190 of strain energy within a circular border 192 of a defined surface. Thus, according to an alternative embodiment of the invention, rock mechanics can be used to model multiple drilling tool designs operating in a geological formation. Then, the modeled drilling tool design that generates highest maximum strain energy on a view of one or more defined surfaces in the formation can be selected. A drilling tool can be made according to the selected design.

FIG. 8(b) shows an example of a fringe chart 200 of strain energy within a circular border 202 of a defined surface.

According to an alternative embodiment of the invention, rock mechanics can be used to model multiple drilling tool designs operating in a geological formation. Then, the modeled drilling tool design that generates the most uniform distribution of maximum principal stresses on a view of one or more defined surfaces in the formation can be selected. A drilling tool can be made according to the selected design.

According to an alternative embodiment of the invention, rock mechanics can be used to model multiple drilling tool designs operating in a geological formation. Then, the modeled drilling tool design that generates the most uniform distribution of a rock strength parameter that predicts a failure mode of the rock formation can be selected. The uniformity of the distribution of such a rock strength parameter may be with respect to the entire surface of the mapped view. The criteria for selecting a uniform distribution may, for example, be the finding of a threshold failure level or value of a particular parameter that covers a certain percentage of the view area. For example, a selection criterion might be a distribution of maximum principal stress at a value of “H” MPA or higher covering 40% or more of the entire viewing area.

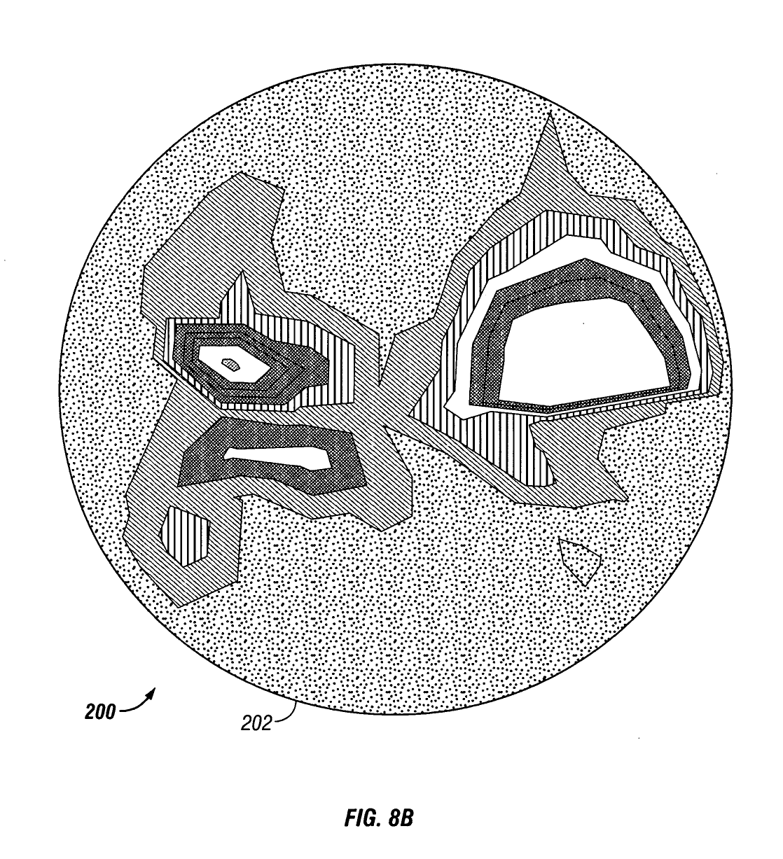

Alternatively, the uniformity of distribution may be on the basis of the distribution over one or more selected regions of the viewing area. FIG. 9 shows one alternative regional division of a viewing area 210 of a formation acted upon by force or by a drilling tool. The regions of division (Regions I, II, and III) are shown as circular rings 212, 214, and 216, respectively, within a circular border surface area 210 underneath a bottom of a bore hole for evaluation of parameter distributions according to certain aspects of the invention. For example, the criteria for selecting a uniform distribution may be the finding of a threshold failure level or value of a particular parameter that covers a certain percentage of the area represented by the ring of Region I. For example, a maximum principal stress at a value of greater than “H” MPA covering 40 % or more of the area of Region I may indicate a good or an optimum mode of failure in the formation and thus a good design for producing such a uniform distribution. Different criteria or the same criteria may be required for the areas of Region II and Region III. For example, 30% of region II with maximum principal stress of “G” MPA and 40% of region III with maximum principal stress of “K” MPA or higher, could be a good criteria or an optimum criteria for a particular formation failure mode. Another criterion is given to measure the relative uniformity of two regions. For example, if T1 stands for the maximum value of a strength parameter in Region I, and T2 for the maximum value of a same strength parameter in Region II (assume T1≧T2), then it is desirable to have a result that the absolute value of (T1−T2)/T1 is less than about 40%. The desired percentage of relative uniformity may be defined at different percentage values for various different strength parameters or for predicting various different failure modes.

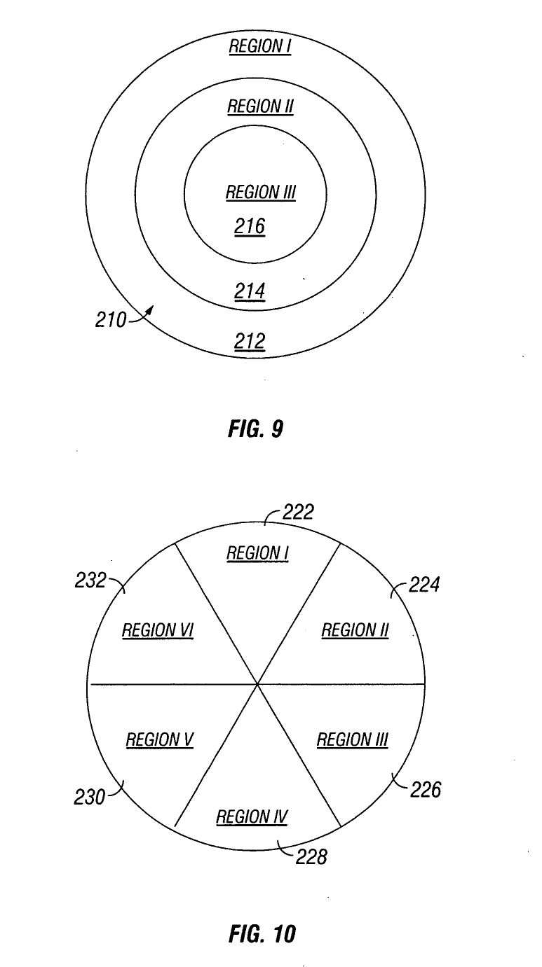

FIG. 10 shows another alternative regional division of pie shaped segments of a circular border surface area 220 underneath a bottom of a bore hole for evaluation of parameter distributions according to certain aspects of the invention. For example, a criterion for selecting a uniform distribution may be the finding of a threshold or critical failure level or value of a particular rock strength parameter that covers a certain percentage of an area represented by a pie segment corresponding to any of areas 222, 224, 226, 228, 230 and 232, of Regions I, II, III, IV, V, or VI, respectively. For example, a maximum principal stress at a value of “H” MPA or higher covering 40 % or more of the area 222 of Region I may be a good failure mode predictor. Different criteria or the same criteria may be required for the areas 222, 224, 226, 228, 230 or 232 of Regions I, II, III, IV, V, or VI, respectively. Alternatively, the criteria may be different for each of the regions. Alternatively, the criteria may be to have at least one point with a value exceeding a critical value. For example, a design may be selected that produces at least one point of maximum principle stress equal to “H” MPA in each of the Regions I, II, III, IV, V, or VI. Other combinations of criteria can be developed and selected by a design engineer to facilitate the method of drill bit, drilling tool and drilling system design according to alternative embodiments of the invention. The criterion is also useful in this case for the relative uniformity of two regions. For example, if T4 stands for the maximum value of a strength parameter in Region IV, and T6 for the maximum value of a same strength parameter in Region VI (assume T4≧T6), then it is desirable to have a result that the absolute value of (T4−T6)/T4 is less than about 40%.

According to another aspect of the invention and without departing from certain other aspects of the invention, drilling tools and drilling system can be made according to a given criteria as disclosed herein and then field tested to establish the validity of the selection or design criteria used.

According to an alternative embodiment of the invention, rock mechanics can be used to model multiple drilling tool designs operating in a geological formation. Then, the modeled drilling tool design that generates the most uniform distribution of maximum von Mises stresses on a view of one or more defined surfaces in the formation can be selected. A drilling tool can be made according to the selected design.

According to an alternative embodiment of the invention, rock mechanics can be used to model multiple drilling tool designs operating in a geological formation. Then, the modeled drilling tool design that generates the most uniform distribution of energy concentration on a view of one or more defined surfaces in the formation can be selected. A drilling tool can be made according to the selected design.

According to an alternative embodiment of the invention, rock mechanics can be used to model multiple drilling tool designs operating in a geological formation. Then, the modeled drilling tool design that generates the most uniform distribution of maximum shear (Tresca) stresses on a view of one or more defined surfaces in the formation can be selected. A drilling tool can be made according to the selected design.

According to an alternative embodiment of the invention, rock mechanics can be used to model multiple drilling tool designs operating in a geological formation. Then, the modeled drilling tool design that generates the most uniform distribution of maximum nominal stresses (for example Moore stress), defined for rock strength measurement, on a view of one or more defined surfaces in the formation can be selected. A drilling tool can be made according to the selected design.

According to an alternative embodiment of the invention, rock mechanics can be used to model multiple drilling tool designs operating in a geological formation. Then, the modeled drilling tool design that generates the most uniform distribution of maximum displacements on a view of one or more defined surfaces in the formation can be selected. A drilling tool can be made according to the selected design.

According to an alternative embodiment of the invention, rock mechanics can be used to model multiple drilling tool designs operating in a geological formation. Then, the modeled drilling tool design that generates the most uniform distribution of maximum strain energies on a view of one or more defined surfaces in the formation can be selected. A drilling tool can be made according to the selected design.

The invention has been described with respect to preferred embodiments. It will be apparent to those skilled in the art that the foregoing description is only an example of embodiments of the invention, and that other embodiments of the invention can be devised which do not depart from the spirit of the invention as disclosed herein. Accordingly, the invention is to be limited in scope only by the attached claims.

What is claimed is:

1. A method for designing a drilling tool having at least one design parameter, comprising:
graphically displaying to a design engineer at least one of rock mechanics effect of the drilling tool drilling in an earth formation;
adjusting a value of a design parameter for the drilling tool; and
repeating the graphically displaying to the design engineer for observing any change in the at least one rock mechanics effect caused by the adjusting the value of the design parameter.

2. The method of claim 1, further comprising repeating the graphically displaying and adjusting at least until the rock mechanics effect indicates a failure mode in the earth formation.

3. The method of claim 1, further comprising repeating the graphically displaying and adjusting until the rock mechanics effect indicates an improved failure mode in the earth formation.

4. The method of claim 1, further comprising repeating the simulating and adjusting until the rock mechanics effect indicates an optimum failure mode in the earth formation.

5. The method of claim 1, further comprising simulating, in the earth formation, the at least one rock mechanics effect of the drilling tool drilling in the earth formation.

6. The method of claim 1, wherein the rock mechanics effect is selected from the group consisting of maximum principal stress, maximum energy, maximum von Mises stress, maximum shear (Tresca) stress, maximum nominal stress (defined for a rock strength measurement), maximum displacement, and maximum strain energy.

7. The method of claim 6, wherein graphically displaying the rock mechanics effect comprises displaying the rock mechanics effect for a plane surface view below a bore hole in the earth formation on a chart selected from the group of a contour chart and a fringe chart.

8. The method of claim 7, wherein the chart has a circular shaped boundary.

9. The method of claim 7, wherein the chart has a rectangular shaped boundary.

10. The method of claim 6, wherein graphically displaying the rock mechanics effect comprises displaying the rock mechanics effect for a curved surface view below a bore hole in the earth formation on a chart selected from the group of a contour chart and a fringe chart.

11. The method of claim 10, wherein the chart has a circular shaped boundary.

12. The method of claim 10, wherein the chart has a rectangular shaped boundary.

13. The method of claim 1, wherein the rock mechanics effect comprises a uniform distribution of rock mechanics effect selected from the group consisting of critical principal stresses, critical energy concentrations, critical von Mises stresses, critical shear (Tresca) stresses, critical nominal stresses (defined for a rock strength measurement), critical displacements, and critical strains.

14. The method of claim 13, wherein graphically displaying the rock mechanics effect comprises displaying the rock mechanics effect for a surface view below a bore hole in the earth formation on a chart selected from the group of a contour chart and a fringe chart.

15. The method of claim 14, wherein the chart has a circular shaped boundary.

16. The method of claim 14, wherein the chart has a rectangular shaped boundary.

17. The method of claim 14, wherein uniform distribution comprises distribution of the same or a higher value for the rock mechanics effect over 40% of the area of the surface view of the chart.

18. The method of claim 17, wherein graphically displaying the rock mechanics effect comprises displaying the rock mechanics effect for a plane surface view below a bore hole in the earth formation on a chart selected from the group of a contour chart and a fringe chart.

19. The method of claim 17, wherein graphically displaying the rock mechanics effect comprises displaying the rock mechanics effect for a curved surface view below a bore hole in the earth formation on a chart selected from the group of a contour chart and a fringe chart.

20. The method of claim 17, wherein uniform distribution comprises distribution of the same or a higher value for the rock mechanics effect over 40% of the area of the surface of the view of the chart.

21. The method of claim 17, wherein the area of the chart is divided into a plurality of regions and the uniform distribution comprises distribution of the same or a higher value for the rock mechanics effect over 40% of the area of at least one of the regions the surface of the view of the chart.

22. The method of claim 17, wherein:
the area of the chart is divided into at least a first region and a second region;
the uniform distribution comprises a relative uniformity of the rock mechanics effect in the first and second regions, and
the relative uniformity is defined by the expression:
((T1−T2)/T1)≦40%;
where:
T1 is a first maximum value of the rock mechanics effect T in the first region,
T2 is a second maximum value of the rock mechanics effect T in the second region, and
it is assumed that T1≧T2.

23. A method for designing a drilling tool having at least one design parameter, comprising:
simulating, in an earth formation, at least one rock mechanics effect of the drilling tool drilling in the earth formation;
graphically displaying to a design engineer the at least one rock mechanics effect of the drilling tool drilling in the earth formation;
adjusting a value of a design parameter for the drilling tool; and
repeating the simulating and graphically displaying to the design engineer for observing any change in the at least one rock mechanics effect caused by the adjusting the value of the design parameter.

24. A method for designing a drilling tool for drilling in an earth formation, the method comprising:
graphically displaying to a design engineer a rock mechanics strength parameter in an earth formation in response to an assumed point force loading;
adjusting the assumed point force loading; and
repeating the graphically displaying and adjusting the point force loading at least until the rock strength parameter indicates a failure mode in the earth formation.

25. The method of claim 24, wherein the graphically displaying further comprises:
assuming a point force loading on a surface of the earth formation; and
using rock mechanics to model a rock strength parameter in the earth formation in response to the point force loading.

26. A method for designing a drilling tool for drilling in an earth formation, the method comprising:
assuming a point force loading on a surface of the earth formation;
using rock mechanics to model a rock strength parameter in the earth formation in response to the point force loading;
graphically displaying the rock strength parameter to a design engineer;
assuming an adjusted point force loading; and
repeating the using of rock mechanics to model the rock strength parameter in response to the point force loading, graphically displaying and assuming an adjusted point force loading at least until the rock strength parameter indicates a failure mode in the earth formation.

27. The method of claim 26, wherein the assuming a point loading comprises assuming a plurality of points each loaded with a force having a magnitude and an angle of application against the surface of the earth formation.

28. The method of claim 26, wherein the using rock mechanics to model a rock strength parameter in the earth formation comprises using a numerical method for rock mechanics modeling of a rock strength parameter.

29. The method of claim 26, wherein the using rock mechanics to model a rock strength parameter in the earth formation comprises using a finite element analysis (FEA) method for rock mechanics modeling of a rock strength parameter.

30. The method of claim 26, wherein the using rock mechanics to model a rock strength parameter in the earth formation comprises using a boundary element method (BEM) for rock mechanics modeling of a rock strength parameter.

31. The method of claim 26, wherein the using rock mechanics to model a rock strength parameter in the earth formation comprises using a simplified analytical method for rock mechanics modeling of a rock strength parameter.

32. The method of claim 26, wherein the rock strength parameter is selected from the group consisting of maximum principal stress, maximum energy, maximum von Mises stress, maximum shear (Tresca) stress, maximum nominal stress (defined for a rock strength measurement), maximum displacement, and maximum strain energy.

33. The method of claim 32, wherein the graphically displaying the rock strength parameter comprises displaying the rock strength parameter for a surface view below a bore hole in the earth formation on a chart selected from the group of a contour chart and a fringe chart.

34. The method of claim 33, wherein the chart has a circular shaped boundary.

35. The method of claim 33, wherein the chart has a rectangular shaped boundary.

36. The method of claim 33, wherein graphically displaying the rock strength parameter comprises displaying the rock strength parameter for a plane surface view below a bore hole in the earth formation.

37. The method of claim 33, wherein the graphically displaying the rock strength parameter comprises displaying the rock strength parameter for a curved surface view below a bore hole in the earth formation.

38. The method of claim 26, wherein the rock strength parameter is a uniform distribution of a rock strength parameter selected from the group consisting of critical principal stresses, critical energy concentrations, critical von Mises stresses, critical shear (Tresca) stresses, critical nominal stresses (defined for a rock strength measurement), critical displacements, and critical strains.

39. The method of claim 38, wherein the graphically displaying the rock strength parameter comprises displaying the rock strength parameter for a surface view below a bore hole in the earth formation on a chart selected from the group of a contour chart and a fringe chart.

40. The method of claim 39, wherein the graphically displaying the rock strength parameter comprises displaying the rock strength parameter for a plane surface view below a bore hole in the earth formation.

41. The method of claim 39, wherein the graphically displaying the rock strength parameter comprises displaying the rock strength parameter for a curved surface view below a bore hole in the earth formation

42. The method of claim 39, wherein the chart has a circular shaped boundary.

43. The method of claim 39, wherein the chart has a rectangular shaped boundary.

44. The method of claim 40, wherein the uniform distribution comprises distribution of a same or a higher value for the rock strength parameter over 40% of the area of the surface of the view of the chart.

45. The method of claim 39, wherein the area of the surface of the view of the chart is divided into a plurality of regions and the uniform distribution comprises distribution of the same or a higher value for the rock strength parameter over 40% of the area of at least one of the plurality of regions the surface of the view of the chart.

46. The method of claim 39, wherein the area of the surface of the view of the chart is divided into at least a first region and a second region, and wherein the uniform distribution comprises a relative uniformity of the rock strength parameter in the first and second regions, and wherein the relative uniformity is defined by the expression:
((T1−T2)/T1)≦40%;
where:
T1 is a first maximum value of the rock strength parameter T in the first region,
T2 is a second maximum value of the rock strength parameter T in the second region, and
it is assumed that T1≧T2.

47. A method for designing a drilling tool for drilling in an earth formation, comprising:
assuming a contact pressure loading on a surface of the earth formation;
using rock mechanics to model a rock strength parameter in the earth formation in response to the contact pressure loading;
graphically displaying the rock strength parameter to a design engineer;
assuming an adjusted contact pressure loading; and
repeating the using of rock mechanics to model the rock strength parameter in response to the contact pressure loading, graphically displaying, and assuming an adjusted contact pressure loading until the rock strength property indicates a failure mode in the earth formation.

48. A method for designing a drilling tool for drilling in an earth formation, the, comprising:
assuming a drilling tool design defined by design parameters;
determining contact pressure loading applied on a surface of the earth formation by the drilling tool according to the design parameters;
using rock mechanics to model a rock strength parameter in the earth formation in response to the contact pressure loading applied by the drilling tool design;
graphically displaying the rock strength parameter to a design engineer;
adjusting at least one drilling tool design parameter; and
repeating the determining of the contact pressure loading applied on the surface of the earth formation, the using rock mechanics to model the rock strength parameter in the earth formation in response to the contact pressure loading, graphically displaying the rock strength property and adjusting at least one drilling tool parameter at least until the rock strength parameter indicates a failure mode in the earth formation.

49. A method for designing a drilling tool for drilling in an earth formation, comprising:
assuming a drilling tool design defined by design parameters;
determining point force loading applied on a surface of the earth formation by the drilling tool according to the design parameters;
using rock mechanics to model the earth formation and to determine a rock strength parameter in the earth formation in response to the point force loading applied by the drilling tool design;
graphically displaying the rock strength parameter to a design engineer;
adjusting at least one drilling tool design parameter; and
repeating the determining of the point force loading applied on the surface of the earth formation, the using rock mechanics to model the earth formation and to determine the rock strength parameter in response to the point force loading, graphically displaying the rock strength property and adjusting at least one drilling tool parameter until the rock strength property indicates a failure mode in the earth formation.

50. The method of claim 49, wherein using rock mechanics to model a rock strength parameter in the earth formation comprises using a numerical method for rock mechanics modeling of a rock strength parameter.

51. The method of claim 50, wherein the numerical method for rock mechanics modeling of a rock strength parameter is selected from the group including a finite element analysis (FEA) method and a boundary element method (BEM).

52. The method of claim 49, wherein the using rock mechanics to model the rock strength parameter in the earth formation comprises using a simplified analytical method for rock mechanics modeling of a rock strength parameter.

53. The method of claim 49, wherein the rock strength parameter is selected from the group consisting of maximum principal stress, maximum energy, maximum von Mises stress, maximum shear (Tresca) stress, maximum nominal stress (defined for a rock strength measurement), maximum displacement, and maximum strain energy.

54. The method of claim 53, wherein the graphically displaying the rock strength parameter comprises displaying the rock strength parameter for a surface view below a bore hole in the earth formation on a chart selected from the group of a contour chart and a fringe chart.

55. The method of claim 53, wherein the graphically displaying the rock strength parameter comprises displaying the rock strength parameter for a plane surface view below a bore hole in the earth formation.

56. The method of claim 53, wherein the graphically displaying the rock strength parameter comprises displaying the rock strength parameter for a curved surface view below a bore hole in the earth formation

57. The method of claim 53, wherein the chart has a circular shaped boundary.

58. The method of claim 53, wherein the chart has a rectangular shaped boundary.

59. The method of claim 49, wherein the rock strength parameter is a uniform distribution of a rock strength parameter selected from the group including critical principal stresses, critical energy concentrations, critical von Mises stresses, critical shear (Tresca) stresses, critical nominal stresses (defined for a rock strength measurement), critical displacements, and critical strains.

60. The method of claim 59, wherein the graphically displaying the rock strength parameter comprises displaying the rock strength parameter for a surface view below a bore hole in the earth formation on a chart selected from the group of a contour chart and a fringe chart.

61. The method of claim 59, wherein the graphically displaying the rock strength parameter comprises displaying the rock strength parameter for a plane surface view below a bore hole in the earth formation.

62. The method of claim 59, wherein the graphically displaying the rock strength parameter comprises displaying the rock strength parameter for a curved surface view below a bore hole in the earth formation.

63. The method of claim 59, wherein the chart has a circular shaped boundary.

64. The method of claim 59, wherein the chart has a rectangular shaped boundary.

65. The method of claim 59, wherein the uniform distribution comprises distribution of a same or a higher value for the rock strength parameter over 40% of the area of the surface of the view of the chart.

66. The method of claim 59, wherein the area of the chart is divided into a plurality of regions and the uniform distribution comprises distribution of a same or a higher value for the rock strength parameter over 40% of the area of a region the surface of the view of the chart.

67. The method of claim 59, wherein the area of the surface of the view of the chart is divided into at least a first region and a second region, and wherein the uniform distribution comprises a relative uniformity of the rock strength parameter in the first and second regions, and wherein the relative uniformity is defined by the expression:
((T1−T2)/T1)≦40%;
where:
T1 is a first maximum value of the rock strength parameter T in the first region,
T2 is a second maximum value of the rock strength parameter T in the second region, and
it is assumed that T1≧T2.

68. A drilling tool designed using the method of any one of claims 1, 23, 24, 26, 47, 48, or 49.
